(19) United States
(12) Patent Application Publication
(10) Pub. No.: US 2004/0265538 A1
(43) Pub. Date: Dec. 30, 2004

(54) Thermal interface apparatus, systems, and methods

(75) Inventor: Joshua Oen, Fremont, CA (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/607,733

(22) Filed: Jun. 26, 2003

(51) Int. Cl. B32B 3/10

(52) U.S. Cl. 428/138

(57) ABSTRACT

An apparatus and system, as well as fabrication methods therefor, may include a unitary layer of electrically non-conductive material having a first surface adjacent a heat sink, a second surface adjacent a heat source, and a plurality of openings that may be communicatively coupled between the first surface and the second surface, wherein the combined area of the plurality of openings comprises a selected percentage of the first surface.

### TECHNICAL FIELD

The subject matter relates generally to apparatus, systems, and methods used to assist in transferring heat from one element or body, such as a circuit, to another, such as a heat sink.

### BACKGROUND INFORMATION

Electronic components, such as integrated circuits, may be assembled into component packages by physically and electrically coupling them to a substrate. During operation, the package may generate heat which can be dissipated to help maintain the circuitry at a desired temperature. Heat sinks, including heat spreaders, may be coupled to the package using a suitable thermal interface to assist in transferring heat from the package to the heat sink.

The interface, which can include several layers of spacers and thermal paste in combination, may provide some degree of heat conduction between the heat source and the heat sink, along with electrical isolation. However, the ability to provide electrical separation may result in reduced heat transfer capability. Different arrangements and/or types of materials in the interface may produce improved performance with respect to both electrical isolation and heat conduction.

### BRIEF DESCRIPTION OF THE DRAWINGS

FIG. 1 is a perspective view of an apparatus according to various embodiments;

FIG. 2 is a perspective view of an apparatus according to various embodiments;

FIG. 3 is a side cut-away view of an apparatus and a system according to various embodiments; and

FIG. 4 is a flow chart illustrating several methods according to various embodiments.

### DETAILED DESCRIPTION

In the following detailed description of various embodiments, reference is made to the accompanying drawings that form a part hereof, and in which are shown by way of illustration, and not of limitation, specific embodiments in which the subject matter may be practiced. In the drawings, like numerals describe substantially similar components throughout the several views. The embodiments illustrated are described in sufficient detail to enable those skilled in the art to practice the teachings disclosed herein. Other embodiments may be utilized and derived therefrom, such that compositional, structural, and logical substitutions and changes may be made without departing from the scope of this disclosure. The following detailed description, therefore, is not to be taken in a limiting sense.

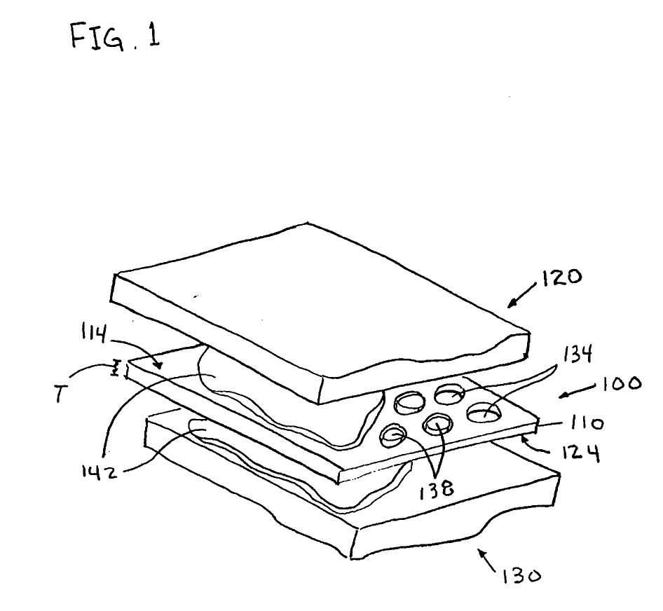

FIG. 1 is a perspective view of an apparatus 100 according to various embodiments. The apparatus 100 may comprise a unitary layer 110 of electrically non-conductive material having a first surface 114 adjacent a heat sink 120, a second surface 124 adjacent a heat source 130, and a plurality of openings 134 that may be communicatively coupled between the first surface 114 and the second surface 124. For the purpose of this disclosure, “electrically non-conductive material” means a material having a dielectric property of greater than about 2500 V/mil (or about 2500 V/0.03 mm).

The combined area of the plurality of openings 134 may comprise a selected percentage of the first surface 114 area, such as at least about 50%, or at least about 60%, or at least about 70%, or at least about 80%, or at least about 90%, or at least about 95%, or no more than about 90%, or no more than about 95% of the first surface 114 area. The combined area of the plurality of openings 134 may also comprise a range of percentages of the first surface 114 area, such as about 50% to about 95%, or about 60% to about 95%, or about 70% to about 95%, or about 80% to about 90%, or about 90% to about 95% of the first surface 114 area.

A selected number of the plurality of openings 134 may comprise one or more regular geometric shapes, such as a substantially circular shape. Regular geometric shapes may include shapes which are substantially circular, elliptic, triangular, rectangular, square, or other multi-sided shapes, including pentagons, hexagons, etc. Some or all of the openings 134 may also comprise one or more irregular geometric shapes, patterned or unpatterned.

If desired, the openings 134 may comprise some selected percentage of the second surface 124 area which is different from a selected percentage of the first surface 114 area. For example, if the openings 134 are formed in the shape of a frustrum of an inverted right circular cone, then a larger diameter of a circle formed in the first surface 114 may communicate through the body of the unitary layer 110 to a smaller diameter of a circle formed on the second surface 124. In this manner, for example, if the combined area of the openings 134 in the first surface 114 comprise at least about 95% of the first surface 114 area, then the combined area of the openings 134 in the second surface 124 might comprise a lesser percentage of the second surface 124 area, such as no more than about 90% of the second surface 124 area.

The unitary layer 110 may comprise any number of materials, including a polymer, or a plurality of glass beads. In addition, or alternatively, the unitary layer 110 may comprise a thermally conductive material. In addition, or alternatively, the unitary layer 110 may comprise a non-woven material.

The apparatus 100 may also include a thermally conductive material 138 located in one or more of the openings 134. The thermally conductive material 138 may be selected from at least one of a solid, liquid, and/or paste.

In some embodiments, the apparatus 100 may comprise a heat source 130, such as a circuit, a die, and/or an integrated circuit package, perhaps including a transponder; and a heat sink 120, such as a peltier cooler, a heat spreader, etc. The unitary layer 110 of electrically non-conductive material may have a substantially uniform thickness T of about 2 mils (about 0.05 mm). In some embodiments the apparatus 100 may comprise one or more layers of thermal interface material 142, perhaps located between the unitary layer 110 of electrically non-conductive material and the heat sink 120 and/or the heat source 130. The thermal interface material 142 may comprise any material which is electrically conductive or non-conductive, and which provides relatively high thermal conductivity, including thermal grease, such as silicone/zinc oxide-based compounds.

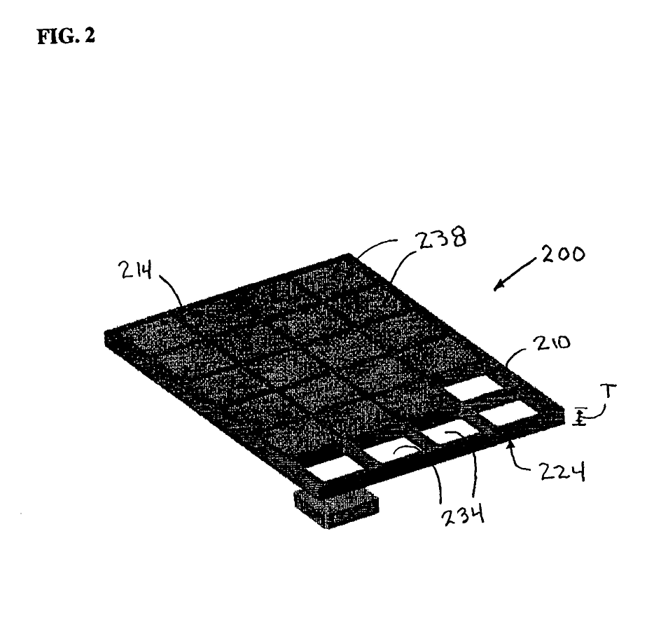

Other embodiments may also be realized. For example, FIG. 2 is a perspective view of an apparatus 200 according to various embodiments. The apparatus 200 may comprise a unitary layer 210, including a plurality of openings 234 that may be communicatively coupled between a first surface 214 and a second surface 224. The apparatus 200 may be located and compressed between a heat sink (not shown) and a heat source (not shown), as noted for FIG. 1. Here the plurality of openings 234 that may be communicatively coupled between the first surface 214 and the second surface 224 are each shown as comprising regular geometric shapes, such as a substantially square shape. Some or all of the openings 234 may also comprise irregular geometric shapes, patterned or unpatterned.

As noted, the openings 234 may have the same, or a different size on the first surface 214 and the second surface 224. Regular geometric objects may be formed by the openings 234, such as a spherical section, a rectangular parallelepiped, a cube, a truncated pyramid, a cylinder, a frustrum, an ellipsoidal section, an elliptic cylinder, an elliptic conical section, an elliptic hyperboloidal section, a sectioned paraboloid of revolution, and/or a sectioned hyperbolic paraboloid. The openings 234 may also be include a plurality of irregular geometric objects, which can be patterned (e.g., figurines, animals, trees, holiday shapes, stars, pillows, twists, wagon wheels, etc.) or unpatterned. The height, shape, and/or spacing of the plurality of substantially similar geometric objects formed by the openings 234 can be selected based on a desired total volume for the openings 234 within the unitary layer 210, and/or a desired thickness T of the unitary layer 210. The openings 234 may also include a thermally conductive material 238 located in one or more of the openings 234. The thermally conductive material 238 may be selected from at least one of a solid, liquid, and/or paste.

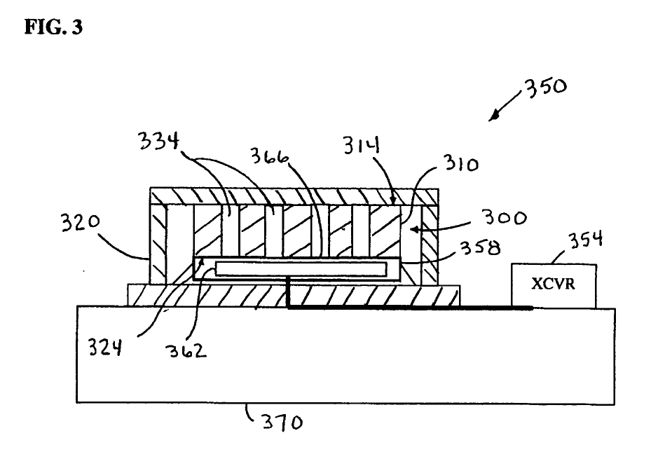

Still other embodiments may be realized. For example, FIG. 3 is a side cut-away view of an apparatus 300 and a system 350 according to various embodiments. The system 350 may include a wireless transceiver 354 (which may include a transponder), and a die 358 including a circuit 362, such as a processor, electrically coupled to the wireless transceiver 354. The system 350 may also include a heat sink 320 and a unitary layer 310 of electrically non-conductive material, which in turn may have a first surface 314 adjacent the heat sink 320, and a second surface 324 adjacent a surface 366 of the die 358. The unitary layer 310, which may comprise a polymer, may include a plurality of openings 334 that may be communicatively coupled between the first surface 314 and the second surface 324, wherein the combined area of the plurality of openings 334 may comprise a selected percentage of the first surface 314, as shown in FIGS. 1 and 2.

The heat sink 320 may comprise any number of devices, including a peltier cooler, and/or a heat spreader. The die 358 may comprise any kind or amount of circuitry 362 and/or components, including a flip-chip, a processor, one or more power transistors, and/or a memory. The die 358 and the wireless transceiver 354 may be coupled to a substrate 370, which may comprise organic or inorganic materials, or combinations of these. The substrate 370 may also comprise flexible materials and/or nonflexible materials. Materials included in the substrate 370 may be non-conductive or conductive, depending upon the configuration and requirements of the apparatus 300 and the system 350.

The apparatus 100, 200, 300, unitary layer 110, 210, 310, first surface 114, 214, 314, heat sink 120, 220, 320, second surface 124, 224, 324, heat source 130, 230, 330, openings 134, 234, 334, thermally conductive material 138, 238, system 350, wireless transceiver 354, die 358, circuit 362, surface 366, and substrate 370 may all be characterized as “modules” herein. Such modules may include hardware circuitry, and/or a processor and/or memory circuits, software program modules and objects, and/or firmware, and combinations thereof, as desired by the architect of the apparatus 100, 200, 300 and system 350, and as appropriate for particular implementations of various embodiments. For example, such modules may be included in a system operations simulation package, such as a software electrical signal simulation package, a power usage and distribution simulation package, a thermo-mechanical stress simulation package, a power/heat dissipation simulation package, and/or a combination of software and hardware used to simulate the operation of various potential embodiments.

It should also be understood that the apparatus and systems of various embodiments can be used in applications other than for coupling and heat transfer between dice and heat sinks, and thus, these embodiments are not to be so limited. The illustrations of apparatus 100, 200, 300, and system 350 are intended to provide a general understanding of the elements and structure of various embodiments, and they are not intended to serve as a complete description of all the features of compositions, apparatus, and systems that might make use of the elements and structures described herein.

Applications that may include the novel apparatus and systems of various embodiments include electronic circuitry used in high-speed computers, communication and signal processing circuitry, data transceivers, modems, processor modules, embedded processors, and application-specific modules, including multilayer, multi-chip modules. Such apparatus and systems may further be included as sub-components within a variety of electronic systems, such as televisions, cellular telephones, personal computers, workstations, radios, video players, vehicles, and others.

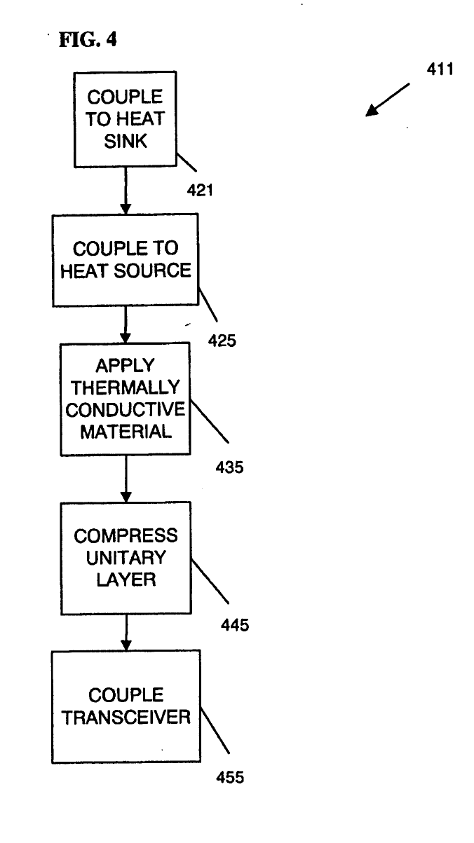

Some embodiments include a number of methods. For example, FIG. 4 is a flow chart illustrating several methods according to various embodiments. Thus, a method 411 may (optionally) begin at block 421 with coupling a heat sink to a first surface of a unitary layer of electrically non-conductive material, and coupling a heat source to a second surface of the unitary layer of electrically non-conductive material at block 425. The unitary layer of electrically non-conductive material may have a plurality of openings that may be communicatively coupled between the first surface and the second surface. The combined area of the openings may comprise a selected percentage of the first surface, as shown in FIGS. 1 and 2.

The method 411 may also include applying a thermally conductive material (possibly selected from at least one of a solid, liquid, and/or paste) to selected ones of the plurality of openings at block 435, as well as compressing the unitary layer of electrically non-conductive material between the heat sink and the heat source at block 445. Finally, the method 411 may include coupling a wireless transceiver to the circuit included in the die at block 455.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

What is claimed is:

1. An apparatus, comprising:
a unitary layer of electrically non-conductive material having a first surface adjacent a heat sink, a second surface adjacent a heat source, and a plurality of openings communicatively coupled between the first surface and the second surface, wherein a combined area the plurality of openings comprises a selected percentage of the first surface.

2. The apparatus of claim 1, wherein selected ones of the plurality of openings comprise a regular geometric shape.

3. The apparatus of claim 2, wherein the regular geometric shape is substantially circular.

4. The apparatus of claim 2, wherein the regular geometric shape is substantially square.

5. The apparatus of claim 1, wherein selected ones of the plurality of openings comprise an irregular geometric shape.

6. The apparatus of claim 1, wherein the combined area of the plurality of openings comprises at least about 90% of the first surface.

7. The apparatus of claim 1, wherein the combined area of the plurality of openings comprises no more than about 95% of the first surface.

8. The apparatus of claim 1, wherein the combined area of the plurality of openings comprises a selected percentage of the first surface and the second surface, wherein the selected percentage of the second surface is different from the selected percentage of the first surface.

9. The apparatus of claim 1, wherein the unitary layer of electrically non-conductive material comprises:
a polymer.

10. The apparatus of claim 1, further comprising:
a thermal interface material located between the unitary layer of electrically non-conductive material and the heat sink.

11. The apparatus of claim 1, wherein the unitary layer of electrically non-conductive material comprises:
a non-woven material.

12. The apparatus of claim 1, wherein the unitary layer of electrically non-conductive material comprises:
a plurality of glass beads.

13. The apparatus of claim 1, further comprising:
a thermally conductive material located in selected ones of the plurality of openings, the thermally conductive material selected from at least one of a solid, a liquid, and a paste.

14. An apparatus, comprising:
a heat source;
a heat sink; and
a unitary layer of electrically non-conductive material having a first surface adjacent the heat sink, a second surface adjacent the heat source, and a plurality of openings communicatively coupled between the first surface and the second surface, wherein a combined area of the plurality of openings comprises a selected percentage of the first surface.

15. The apparatus of claim 14, wherein the unitary layer of electrically non-conductive material comprises:
a polymer.

16. The apparatus of claim 14, wherein the unitary layer of electrically non-conductive material has a substantially uniform thickness of about 0.05 mm.

17. The apparatus of claim 14, further comprising:
a thermal interface material located between the unitary layer of electrically non-conductive material and the heat source.

18. The apparatus of claim 14, wherein the heat source comprises an integrated circuit package including a transponder.

19. The apparatus of claim 14, wherein the heat source comprises a die.

20. The apparatus of claim 14, wherein the heat sink comprises a heat spreader.

21. The apparatus of claim 14, wherein the combined area of the plurality of openings comprises no more than about 90% of the first surface.

22. The apparatus of claim 14, wherein the combined area of the plurality of openings comprises no more than about 95% of the first surface.

23. A system, comprising:
a wireless transceiver;
a die including a die surface and a circuit electrically coupled to the wireless transceiver;
a heat sink; and
a unitary layer of electrically non-conductive material having a first surface adjacent the heat sink, a second surface adjacent the die surface, and a plurality of openings communicatively coupled between the first surface and the second surface, wherein a combined area of the plurality of openings comprises a selected percentage of the first surface.

24. The system of claim 23, wherein the wireless transceiver comprises:
a transponder.

25. The system of claim 23, wherein the unitary layer of electrically non-conductive material comprises:
a polymer.

26. A method, comprising:
coupling a heat sink to a first surface of a unitary layer of electrically non-conductive material; and
coupling a heat source to a second surface of the unitary layer of electrically non-conductive material, wherein the unitary layer of electrically non-conductive material has a plurality of openings communicatively coupled between the first surface and the second surface, and wherein a combined area of the plurality of openings comprises a selected percentage of the first surface.

27. The method of claim 26, further comprising:
applying a thermally conductive material selected from at least one of a solid, a liquid, and a paste to selected ones of the plurality of openings.

28. The method of claim 26, further comprising:
compressing the unitary layer of electrically non-conductive material between the heat sink and the heat source.

29. The method of claim 26, wherein the unitary layer of electrically non-conductive material comprises:
a polymer.

30. The method of claim 26, further comprising:
coupling a wireless transceiver to a circuit included in the die.
